(19) United States
(12) Patent Application Publication
(10) Pub. No.: US 2013/0260195 A1
(43) Pub. Date: Oct. 3, 2013

(54) OIL-COOLED LITHIUM BATTERY MODULE

(71) Applicant: Shijin Long, Ningde City (CN)

(72) Inventor: Shijin Long, Ningde City (CN)

(21) Appl. No.: 13/437,148

(22) Filed: Apr. 2, 2012

(51) Int. Cl. H01M 10/50; H01M 2/36; H01M 2/08

(52) U.S. Cl. 429/83; 429/120

(57) ABSTRACT

This invention belongs to the category of the lithium battery technology, specially, it relates to an oil-cooled lithium battery module comprising of an oil cooling system and a lithium battery module, wherein the lithium battery module immerged in the oil cooling system and composed of a battery base, a battery core within a core rubber sleeve as well as a press plate, a PCB support plate and a top cap which are disposed in sequence at the front end of the battery core. The top cap is sealingly connected with the battery base, which houses the core rubber sleeve. In comparison with the prior art, the oil cooling system in the present invention controls the oil temperature to ensure that the battery core can run under normal ambient temperature.

### FIELD OF THE INVENTION

This invention pertains to the category of the lithium battery technology, more particularly, the invention relates to an oil-cooled lithium battery module.

### BACKGROUND OF THE INVENTION

Along with gradual exhaustion of traditional resources and enhanced awareness of environmental protection, people are focusing on environmental protection in the urgent hope of traditional resources being replaced by green ones. Since lithium batteries, as one kind of green energy resource, have the advantages of high energy density, high voltage and low self-discharge rate, they have gained more and more popularity.

However, by now the accumulators widely used in automotive vehicles are still lead-acid batteries. In fact, there has not been established an industrialized and mass market by using the lithium batteries to replace the lead-acid batteries. One of the reasons is that the high temperature performance of lithium batteries is not suitable for severe outdoor environment while its low temperature discharge performance is not as good as traditional lead-acid batteries. In order to enable lithium batteries to operate under normal environment, they are generally built in a system with heating and cooling functions, therefore the lithium batteries can still work under normal temperature by means of heating or cooling when the ambient temperature is either too low or too high.

Currently, water cooling is mainly adopted as the cooling strategy for lithium batteries. However, the positive electrode, negative electrode and battery can of lithium batteries cannot directly contact with water, or otherwise short circuit will occur and lead to accidents. Therefore, the water-cooled lithium batteries are still under research and development.

In consideration of aforesaid problems, the inventor of the present invention considers adopting an oil-cooled lithium battery module, where the cooling and heating can be properly achieved for lithium battery pack and operation safety is guaranteed.

### SUMMARY OF THE INVENTION

In view of the abovementioned problems, it is one object of the invention to overcome the drawbacks of the prior art by providing an oil-cooled lithium battery module, where the cooling and heating can be properly achieved for lithium battery pack and operation safety is guaranteed.

To achieve the aforesaid object, the adopted technical solution is described below:

An oil-cooled lithium battery module, in accordance with this invention, comprises an oil cooling system and a lithium battery module, wherein the lithium battery module is disposed within the oil cooling system and composed of a battery base, a battery core within a core rubber sleeve as well as a press plate, a PCB support plate and a top cap which are disposed in sequence at the front end of the battery core. The top cap is sealingly connected with the battery base, which houses the core rubber sleeve. The PCB support plate has two functions: one is that it presses the upper end of the battery core to prevent the core from going up and the other one is that it serves as a support platform for PCB, and meanwhile other electronic elements such as fuses can also be fixed on such platform. Furthermore, the top cap also presses on the press plate to prevent it from going up and enable the press plate to firmly press upon the core rubber sleeve underneath. In this way, sealing is ensured.

As an improvement to the oil-cooled lithium battery module provided by the invention, the gap above said press plate is filled with sealants to prevent oil from spilling upwards.

As an improvement to the oil-cooled lithium battery module provided by the invention, a locating slot is disposed within said battery base and said core rubber sleeve is fixed within said locating slot.

As an improvement to the oil-cooled lithium battery module provided by the invention, a core rubber mat is disposed between said core rubber sleeve and said battery base to provide buffering effects.

As an improvement to the oil-cooled lithium battery module provided by the invention, clamp hooks are disposed within said battery base, and said press plate is sealingly clamped at said battery base via the clamp hooks.

As an improvement to the oil-cooled lithium battery module provided by the invention, said top cap is fixed on said battery base by means of ultrasonic welding and hot-melt riveting.

As an improvement to the oil-cooled lithium battery module provided by the invention, said press plate is a double molded part, in which the flexible rubber of the secondly molded portion contacts with the core rubber sleeve. There is a certain pre-pressing between the flexible rubber and the core rubber sleeve for leakage prevention after the press plate is pressed into the clamp hooks. In addition, the secondly molded portion of the press plate can also prevent oil from spilling upwards.

As an improvement to the oil-cooled lithium battery module provided by the invention, said oil cooling system includes an oil container.

As an improvement to the oil-cooled lithium battery module provided by the invention, said oil container is disposed with an oil injection orifice and an oil discharge orifice.

Compared with the prior art, the oil cooling system provided by the invention can control the oil temperature to ensure that the battery core works under normal temperature environment. The lithium batteries can still work under normal temperature by means of heating or cooling when the ambient temperature is either too low or too high. Meanwhile, several leakage-proof structures (including the core rubber sleeve, the press plate and sealants) are disposed at one end of a battery core tab to prevent oil leakage, thereby ensuring safe and reliable operation of the battery core. In addition, the oil cooling system provided herein can replace wind or water cooling systems applied in conventional batteries, therefore the internal structure of the battery pack is simplified and production costs are reduced accordingly.

### BRIEF DESCRIPTION OF THE DRAWINGS

FIG. 1 is a three-dimensional view of an oil-cooled lithium battery module in accordance with the present invention;

FIG. 2 is a sectional view of the oil-cooled lithium battery module in accordance with the present invention;

FIG. 3 is an exploded view of the oil-cooled lithium battery module in accordance with the present invention;

FIG. 4 is a sectional view of a battery core of the oil-cooled lithium battery module in accordance with the present invention; and

FIG. 5 is an enlarged view of portion A of FIG. 4.

### DETAILED DESCRIPTION OF THE EMBODIMENT

The embodiment and advantages of the invention is explained in further detail below with the aid of the example embodiment and attached drawings. It should be noted that the following example is intended to describe and not to limit the invention.

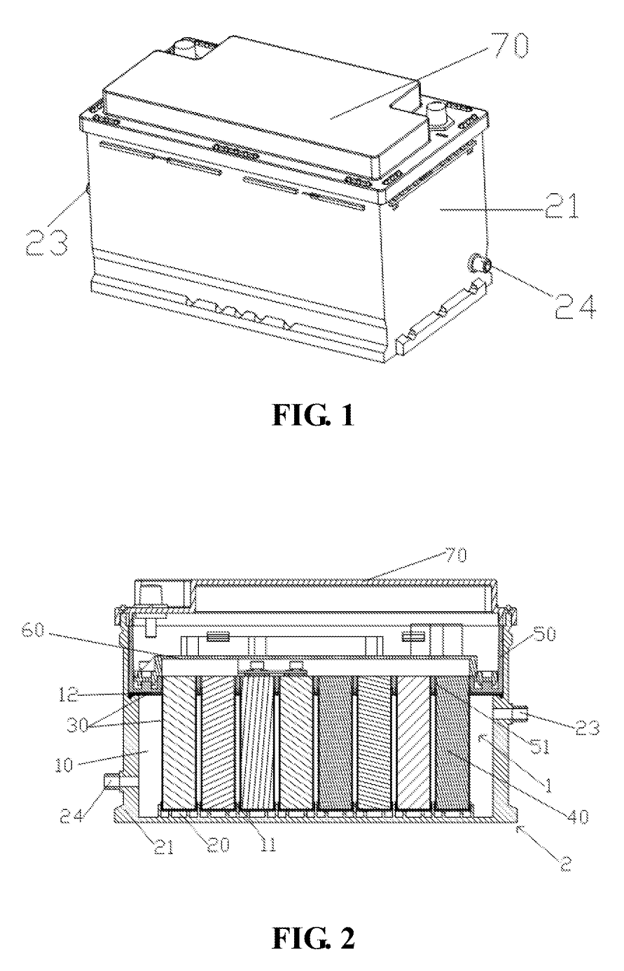

As shown in FIGS. 1-5, an oil-cooled lithium battery module, in accordance with the present invention, comprises an oil cooling system 2 and a lithium battery module 1, wherein the lithium battery module 1 is disposed within the oil cooling system 2 and composed of a battery base 10, a battery core 40 within a core rubber sleeve 30 as well as a press plate 50, a PCB support plate 60 and a top cap 70 which are disposed in sequence at the front end of the battery core 40. The top cap 70 is sealingly connected with the battery base 10, which houses the core rubber sleeve 30.

The gap above said press plate 50 is filled with sealants 51.

A locating slot 11 is disposed within said battery base 10 and said core rubber sleeve 30 is fixed in said locating slot 11.

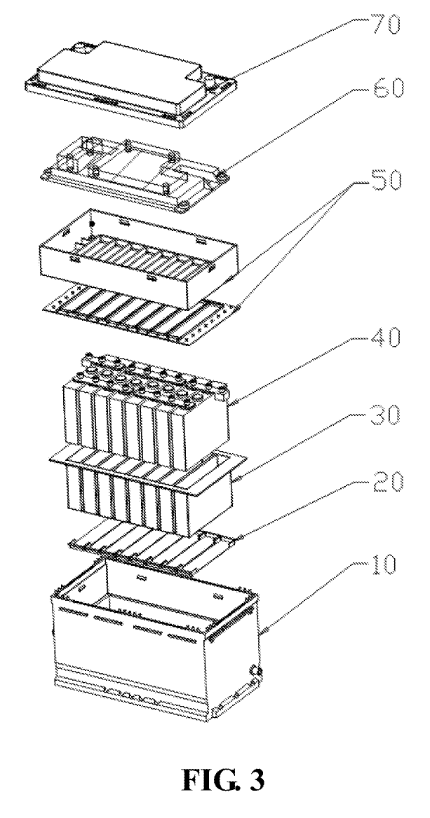

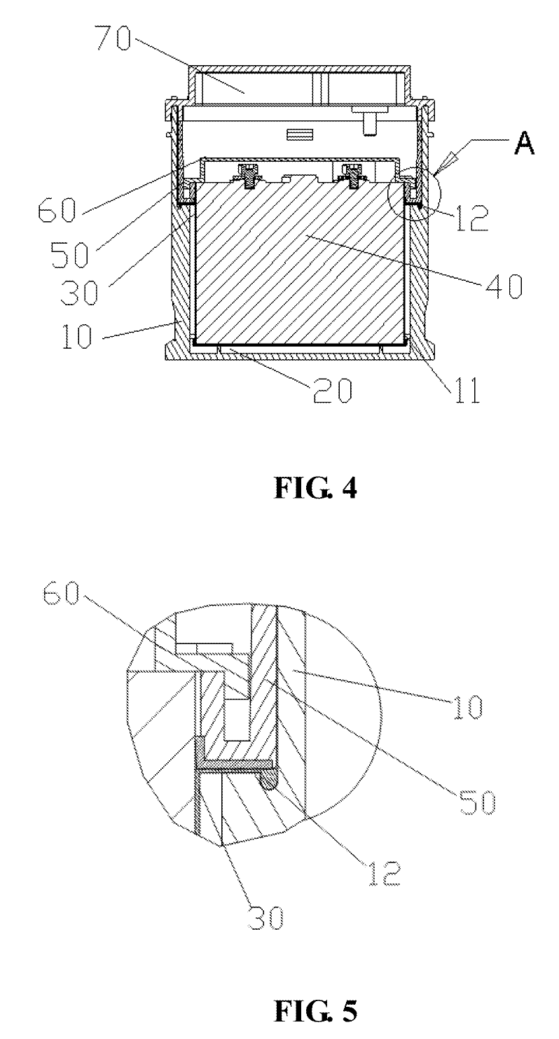

A core rubber mat 20 is disposed between said core rubber sleeve 30 and said battery base 10 (as shown in FIGS. 3 and 4).

Clamp hooks 12 are disposed within said battery base 10 (as shown in FIG. 5) and said press plate 50 is sealingly clamped within said battery base 10 via the clamp hooks 12.

Said top cap 70 is fixed on said battery base (10) by means of ultrasonic welding and hot-melt riveting.

Said press plate 50 is a double molded part.

Said oil cooling system 2 includes an oil container 21.

Said oil container 21 is disposed with an oil injection orifice 23 and an oil discharge orifice 24 (as shown in FIGS. 1 and 2).

The assembly procedures of the oil-cooled lithium battery module are described below:

Step 1: Firstly, put the battery cores 40 into the core rubber sleeve 30 one by one, and then place the battery cores 40 covered with core rubber sleeve 30 into the locating slot 11 of the battery base 10. A core rubber mat 20 is disposed between said battery cores 40 and said battery base 10 to provide buffering effects. It should be noted that the edge of core rubber sleeve 30 needs to be pressed in the corresponding groove of the battery base 10.

Step 2: Assembly the press plate 50. Six clamp hooks 12 are disposed at the inner side of the battery base 10 and the press plate 50 is clamped after being pressed into the clamp hooks 12. As the press plate 50 is a double molded part, in which the flexible rubber of the secondly molded portion contacts with the core rubber sleeve 30. There is a certain pre-pressing between the flexible rubber and the core rubber sleeve 30 for leakage prevention after the press plate 50 is pressed into the clamp hooks 12. In addition, the secondly molded portion of the press plate 50 can also prevent oil from spilling upwards.

Step 3: Sealants injection. As there is a gap above the press plate 50 (flexible rubber), sealants 51 can be injected into the gap to prevent oil from spilling upwards. In this way, oil is prevented from spilling upwards.

Step 4: Mount battery core braces to connect the battery cores 40.

Step 5: Mount PCB support plate 60. The PCB support plate 60 has two functions: one is that it presses the upper end of the battery core to prevent the core from going up and the other one is that it serves as a support platform for PCB, and meanwhile other electronic elements such as fuses can also be fixed on such platform.

Step 6: Connect the main positive/negative output wires, and preferably the flexible leads.

Step 7: Mount the top cap 70. The top cap is firstly processed by ultrasonic welding and then the hot-melt riveting. The top cap 70 also presses on the press plate 50 to prevent the press plate 50 from going up. Consequently, the press plate 50 firmly presses on the core rubber sleeve 30, thereby sealing is ensured. Until not, the lithium battery module is completed assembled.

Step 8: The assembled lithium battery module 1 is placed into the oil container 21 of the oil cooling system 2 and the oil temperature is controlled via the oil temperature control system, so that the temperature of the battery cores 40 within the lithium battery module 1 is controlled and the battery cores 40 can work under normal temperature. When the lithium battery module is under operation, the oil level shall be controlled below the clamp hooks 12.

With respect to the above eight steps, the first three ones play a critical part in sealing and leakage prevention. In case the core rubber sleeves 30 is damaged, the press plate 50 will cooperate with the battery cores 40 to form the second defense as described in step 2. If there is any drawback to the second two defenses, the sealants described in step 3 can provide the sealing effects. Therefore the oil-cooled lithium battery module can work safely under normal ambient temperature based on the aforesaid three defenses and it is possible for the lithium batteries provided by the invention to be used in automotive vehicles.

While particular of the invention have been shown and described, it will be readily apparent to those skilled in the art that that changes and modifications may be made without departing from the this invention in its broader aspects. The aforementioned embodiment is only an example of the invention and shall not be restricted to the above description. The terms used in the specification are intended to illustrate and not to limit this invention.

What is claimed is:

1. An oil-cooled lithium battery module, comprising:
an oil cooling system (2) and a lithium battery module (1),
wherein the lithium battery module (1) is disposed within the oil cooling system (2),
the lithium battery module (1) is composed of a battery base (10), a battery core (40) within a core rubber sleeve (30) as well as a press plate (50), a PCB support plate (60) and a top cap (70), which are disposed in sequence at the front end of the battery core (40),
the top cap (70) is sealingly connected with the battery base (10), and
the core rubber sleeve (30) is housed by the battery base (10).

2. The oil-cooled lithium battery module according to claim 1, wherein the gap above said press plate (50) is filled with sealants (51).

3. The oil-cooled lithium battery module according to claim 1, wherein a locating slot (11) is disposed within said battery base (10) and said core rubber sleeve (30) is fixed in said locating slot (11).

4. The oil-cooled lithium battery module according to claim 1, wherein a core rubber mat (20) is disposed between said core rubber sleeve (30) and said battery base (10).

5. The oil-cooled lithium battery module according to claim 1, wherein clamp hooks (12) are disposed within said battery base (10), said press plate (50) is sealingly clamped within said battery base (10) via the clamp hooks (12).

6. The oil-cooled lithium battery module according to claim 1, wherein said top cap (70) is fixed on said battery base (10) by means of ultrasonic welding and hot-melt riveting.

7. The oil-cooled lithium battery module according to claim 1, wherein said press plate (50) is a double molded part.

8. The oil-cooled lithium battery module according to claim 1, wherein the oil cooling system (2) includes an oil container (21).

9. The oil-cooled lithium battery module according to claim 8, wherein said oil container (21) is disposed with an oil injection orifice (23) and an oil discharge orifice (24).
